(19) United States
(12) Patent Application Publication
(10) Pub. No.: US 2017/0056134 A1
(43) Pub. Date: Mar. 2, 2017

(54) DENTAL ABUTMENTS AND ASSOCIATED SYSTEMS AND METHODS

(71) Applicant: Zimmer, Inc., Warsaw, IN (US)

(72) Inventor: Michael Cordonnier, Encinitas, CA (US)

(21) Appl. No.: 15/249,191

(22) Filed: Aug. 26, 2016

Related U.S. Application Data
(60) Provisional application No. 62/211,138, filed on Aug. 28, 2015.

(51) Int. Cl. A61C 8/00; A61C 13/00

(52) U.S. Cl. CPC A61C 8/0013; A61C 8/0056; A61C 8/0074; A61C 8/0016; A61C 8/006; A61C 13/0004; A61C 13/0018; A61C 8/0068; A61C 8/0027

(57) ABSTRACT

Dental abutments comprising machined apical portions and additively formed coronal portions and related methods are described herein. The abutment has a machined apical portion and additive manufactured coronal portion for supporting a dental prosthesis. The apical portion has a main body having a top surface, an opposed bottom surface, and a screw-machined implant interface extending from the bottom surface that can be matingly engageable with a corresponding interface receptacle disposed in a dental implant. The coronal portion is additively formed from a second material on the top surface of the main body of the apical portion.

### RELATED APPLICATIONS

This application claims the benefit of priority to U.S. Provisional Patent Application Ser. No. 62/211,138, filed Aug. 28, 2015, the content of which is incorporated herein by reference in its entirety.

### FIELD

The present disclosure relates to abutments for use in dental implant systems and, more particularly, to abutments having a machined apical portion and an additive-manufactured coronal portion and associated methods.

### BACKGROUND

This section provides background information related to the present disclosure, which is not necessarily prior art.

Dental implants are commonly used as anchoring members for dental restorations in order to provide prosthetic teeth at one or more sites in a patient's mouth where the patent's original teeth were lost or damaged. Certain implant systems can include a dental implant made from a suitable biocompatible metal, such as titanium. The dental implant can be implanted into the patient's upper or lower jaw to provide an anchoring member for a dental abutment, which in turn serves an interface between the implant and a dental prosthesis. The dental prosthesis can include a porcelain crown. Such abutments can include specialized surfaces for engaging the implant and supporting dental prosthesis.

### SUMMARY

This section provides a general summary of the disclosure, and is not a comprehensive disclosure of its full scope or all of its features.

The present inventors have recognized that, among other things, dental abutments and systems comprising dental abutments having a decreased cost and manufacturing time over conventional dental abutments are desirable. Conventional dental abutments are manufactured using high-precision subtractive manufacturing techniques such as screw-machining and multi-axis milling to form both the implant engaging (or apical) and prosthesis engaging (or coronal) surfaces. Accordingly, the present teachings provide for dental abutments comprising machined apical portions and additively formed coronal portions and related methods. In one aspect, an abutment can comprise an apical portion and a coronal portion. The apical portion can comprise a main body having a top surface, an opposed bottom surface, and a screw-machined implant interface extending from the bottom surface that can be matingly engageable with a corresponding interface receptacle disposed in a dental implant. The apical portion can comprise a first material. The coronal portion can be additively formed from a second material on the top surface of the main body of the apical portion and can support a dental prosthesis. In another aspect, such dental abutments can be incorporated into a dental system. The dental system can further comprise an elongate bridge. Each of the plurality of dental abutments can be selectively spaced along the bridge at selected locations that can correspond to selected tooth roots of a patient.

In another aspect, the present teachings provide for a method of manufacturing an abutment for use with a dental implant, the method comprising: providing or receiving a metal substrate that can comprise a main body having a top surface; and selectively bonding a plurality of layers of a second material to a top surface of the metal substrate to form a coronal portion that can support a dental prosthesis. Optionally, the method can further comprise screw machining an implant interface in a bottom surface of the metal substrate to form an implant interface that can be matingly engageable with a corresponding interface receptacle disposed in a dental implant.

In another aspect, the present teachings provide for a method of manufacturing an abutment for use with a dental implant, the method comprising: providing or obtaining a plurality of metal substrates, where each metal substrate can have a main body and a top surface; screw machining an implant interface in a bottom surface of the metal substrate to form an implant interface that can be matingly engageable with a corresponding interface receptacle disposed in a dental implant; and selectively bonding a plurality of layers of a second material to the top surface of the metal substrate to form a coronal portion that can support a dental prosthesis. Optionally, the method can further comprise coupling each of the plurality of metal substrates to an elongate bridge such that each of the plurality of metal substrates can be spaced along the bridge at selected locations that can correspond to selected tooth roots of a patient.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective exploded view of an exemplary abutment with an implant.

FIG. 2 is a side view of an exemplary abutment and implant.

FIG. 3 is a flow chart illustrating an exemplary method of manufacturing an abutment for use in conjunction with a dental implant.

FIG. 4 is a perspective exploded view of an exemplary abutment having a retaining screw, and an implant.

FIG. 5 is a side view of an exemplary abutment having a retaining screw.

FIG. 6 is a flow chart illustrating an exemplary method of manufacturing a plurality of abutments for use in conjunction with dental implants.

FIG. 7A is a top view of an exemplary dental apparatus having multiple abutments.

FIG. 7B is a side view of the exemplary dental apparatus of FIG. 7A.

FIG. 7C is a perspective view of the exemplary dental apparatus of FIG. 7A.

FIG. 8A is a top view of an exemplary dental apparatus having multiple abutments.

FIG. 8B is a bottom view of the exemplary dental apparatus of FIG. 8A.

FIG. 8C is a side view of the exemplary dental apparatus of FIG. 8A.

FIG. 9 illustrates a crown positioned on an exemplary abutment.

FIG. 10 illustrates a side view of an exemplary dental assembly system.

FIG. 11 is a flow chart illustrating an exemplary method of manufacturing a dental assembly for use in conjunction with dental implants.

Corresponding reference numerals indicate corresponding parts throughout the several views of the drawings.

### DETAILED DESCRIPTION

Example embodiments will now be described more fully with reference to the accompanying drawings.

The present teachings provide for dental abutments comprising machined apical portions and additively formed coronal portions and related methods. Such dental abutments and systems comprising dental abutments can have a decreased cost and manufacturing time over conventional dental abutments.

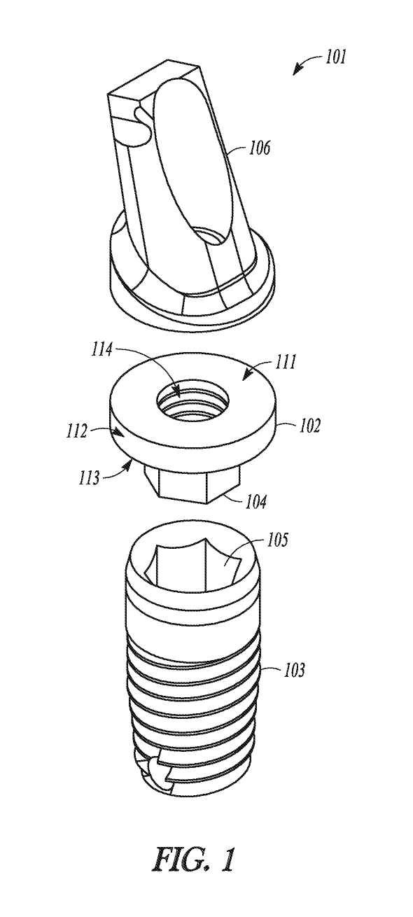

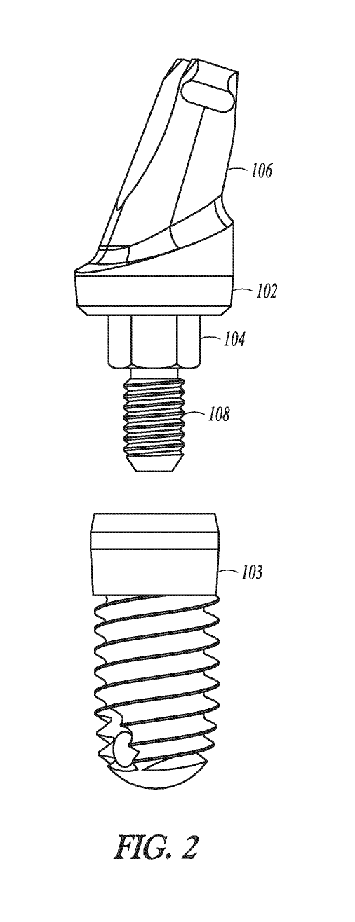

With reference to FIGS. 1 and 2, a dental abutment 101 for use in a dental implant system can comprise an apical portion 102 and a coronal portion 106. The apical portion 102 can comprise a main body 112 having a top surface 111, an opposed bottom surface 113, and an implant interface 104 extending from the bottom surface 113. The implant interface 104 can be matingly engageable with a corresponding interface receptacle 105 disposed in or on a dental implant 103. The implant interface 104 can be a screw-machined implant interface, such as, for example and without limitation, computer numerical controlled Swiss screw machined implant interface 104. The apical portion 102 can have a hole 114 disposed therein extending along a longitudinal axis from the top surface 111 to the bottom surface 113 thereof. The apical portion 102 can comprise a first material. The first material can comprise titanium, a titanium alloy, or a cobalt chrome.

In another aspect, the first material can include plastics and ceramics. In one aspect, the first material can be a plastic that is suitable for additive manufacturing processes. In another aspect, the first material can be a ceramic. For example, ceramics used with technologies that can print ceramics in a non-sintered state or ceramics used with a polymer binder can be used with a laser sintering process. In one aspect, the plastic and ceramic materials can be used to create temporary restorations. In one aspect, the temporary restorations can match the final or permanent restoration, at least in the area of the emergence profile. During healing, the emergence profile of the temporary prosthesis can shape soft tissue to match the emergence profile of the final prosthesis that will be subsequently installed after sufficient healing.

The interface receptacle 105 and the implant interface 104 can comprise male and female mating members. In one aspect illustrated in FIG. 1, the implant interface 104 can comprise a male hexagonal member where a circumference of a cross-section of the implant interface 104 is hexagonal. Likewise, the interface receptacle 105 can comprise a female hexagonal member where a circumference of cross-section of the interface receptacle 105 is hexagonal. However, implant interface 104 and mating interface receptacle 105 pairs can be reversed and, additionally or alternatively, can each have cross-sections that can be, for example and without limitation, conical, spline, octagonal, lobular, or the like.

In another aspect, a coronal portion 106 for supporting a dental implant 103 can be disposed on the top surface 111 of the main body 112 of the apical portion 102. The coronal portion 106 can be additively formed from a second material on the top surface 111 of the main body 112 of the apical portion 102. The coronal portion 106 can be selectively additively formed via three-dimensional printing or additive manufacturing processes. The additive manufacturing process can comprise selective direct metal laser sintering of at least a second material on the top surface. The second material can comprise a titanium powder, resulting in an at least partially laser sintered titanium coronal portion 106, or a titanium alloy powder, resulting in an at least partially laser sintered titanium alloy coronal portion 106. Additionally or alternatively, the additive manufacturing process can comprise selective electron-beam melting of the second material. The second material can comprise a titanium powder, resulting in an at least partially electron-beam melted titanium coronal portion 106, or a titanium alloy powder, resulting in an at least partially electron-beam melted titanium alloy coronal portion 106.

Also, FIG. 1 illustrates an exploded view where the coronal portion 106 is not attached to the apical portion 102 in order to fully describe the abutment 101, but it should be understood that the finished article will comprise the coronal portion 106 coupled to the apical portion 102 as illustrated in FIG. 2. FIG. 2 includes a retaining screw 108 to anchor the abutment 101 to the implant, as discussed herein. In another aspect illustrated in FIG. 9, an exemplary implant system comprising an abutment 101 will, in an implanted configuration, comprise a dental prosthesis (e.g., a crown 907) secured onto and covering the coronal portion 106 of an abutment 101 while the implant interface 104 remains uncovered by the crown 907.

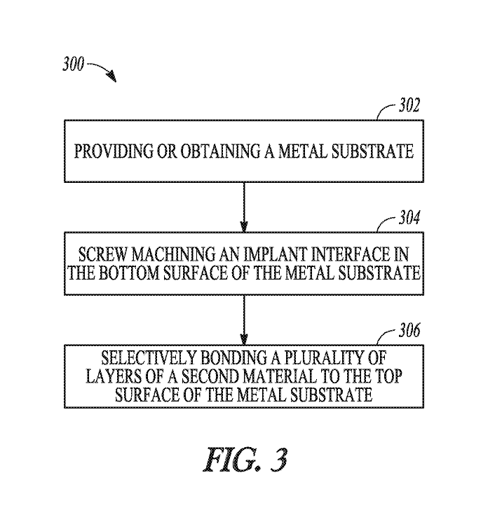

In another aspect illustrated in FIG. 3, the present teachings provide for a method 300 of manufacturing an abutment 101 for use with a dental implant 103. The method 300 can comprise (i) providing or obtaining a metal substrate comprising a main body and a top surface (step 302); and (ii) selectively bonding a plurality of layers of a second material to the top surface of the metal substrate to form a coronal portion that can support a dental prosthesis (step 306). The method can optionally comprise screw machining an implant interface in a bottom surface of the metal substrate to form an implant interface that can be matingly engageable with a corresponding interface receptacle disposed in a dental implant (step 304). Any of the materials, screw machining methods, and additive manufacturing methods described with respect to FIGS. 1 and 2 can be used in this or subsequent manufacturing methods provided herein. The method can optionally further comprise inserting a retaining screw longitudinally through a hole disposed in the metal substrate extending from the top surface to a bottom surface thereof prior to selectively bonding the plurality of layers of a second material to the top surface of the metal substrate as described further below.

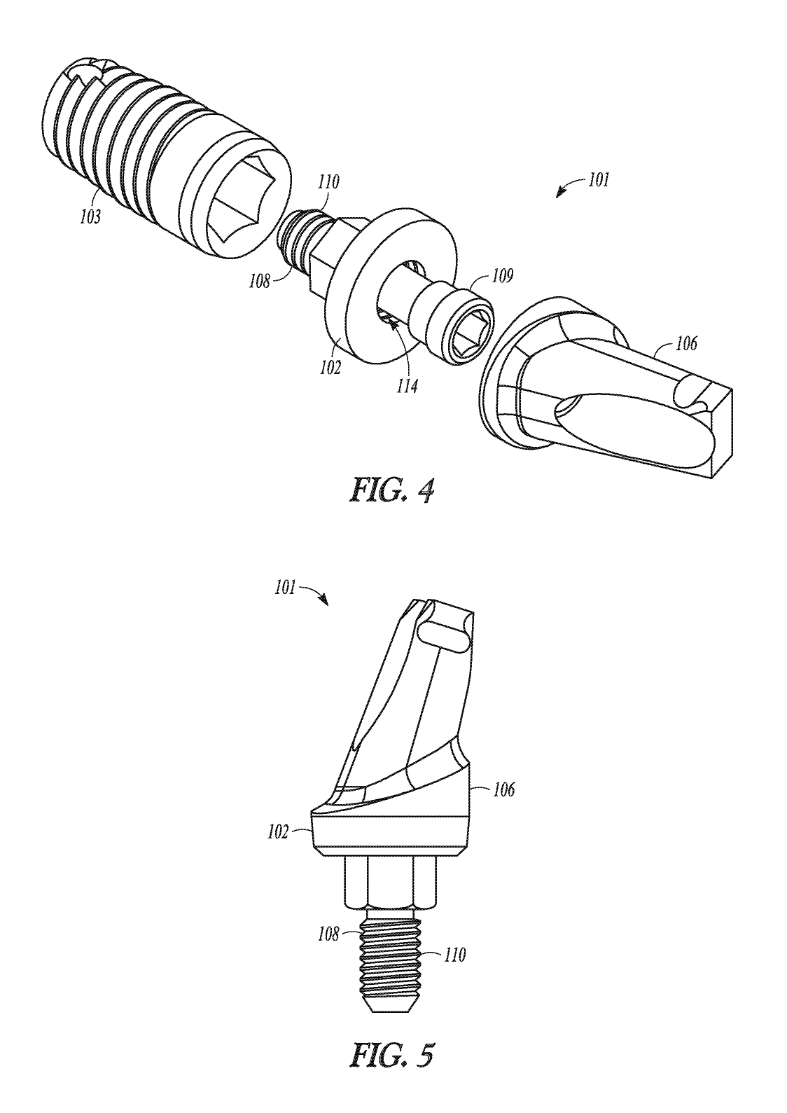

In another aspect illustrated in at least FIGS. 4 and 5, the abutment 101 can further comprise a retaining screw 108 extending longitudinally through the hole 114 disposed in the apical portion 102 in order to anchor the abutment 101 to an implant 103. The retaining screw 108 can comprise a head 109 that is at least partially encapsulated by the coronal portion 106 and a threaded end 110 extending at least partially through the hole 114 disposed in the apical portion 102. Though shown in an exploded view in FIG. 4 in order to fully describe the abutment 101, the additive manufactured coronal portion 106 will completely encapsulate the head 109 of retaining screw 108 subsequent to formation of the coronal portion 106. Accordingly, the retaining screw 108 is secured within the abutment 101 and the head 109 is not visible as illustrated in FIG. 5.

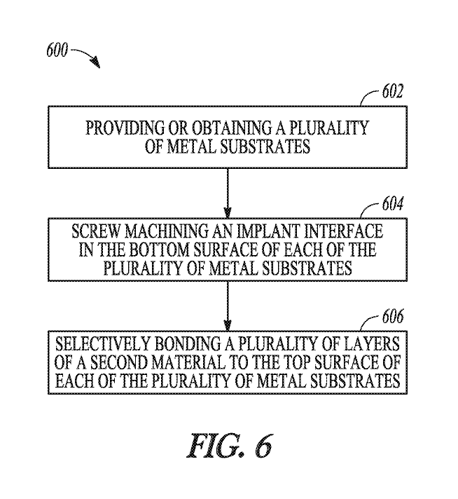

In another aspect illustrated in FIG. 6, the present teachings provide for another method 600 of manufacturing an abutment 101 for use with a dental implant 103. The method 600 can comprise (i) providing or obtaining a plurality of metal substrates, where each metal substrate can have a main body and a top surface (step 602); (ii) screw machining an implant interface in a bottom surface of each of the plurality of metal substrate to form an implant interface that is matingly engageable with a corresponding interface receptacle disposed in a corresponding dental implant (step 604); and (iii) selectively bonding a plurality of layers of a second material to the top surfaces of each of the plurality of metal substrates to form a coronal portion that can support a corresponding dental prosthesis (step 606). Any of the materials, screw machining methods, and additive manufacturing methods described with respect to any other Figures can be used in this method. Optionally, the method can further comprise inserting a retaining screw longitudinally through a hole disposed in the metal substrate extending from the top surface to a bottom surface thereof prior to selectively bonding the plurality of layers of a second material to the top surface of the metal substrate. Optionally, the method can further comprise coupling each of the plurality of metal substrates to an elongate bridge such that each of the plurality of metal substrates can be spaced along the bridge at selected locations that can correspond to selected tooth roots of a patient as described further below. Employing a batch process to form coronal portions on the top surfaces of the main bodies of the apical portions can further reduce the resources required over that required for serially manufacturing the dental abutments described herein.

In another aspects, dental systems comprising a plurality of abutments coupled to or interconnected by a bridge are provided. The plurality of dental abutments can comprise any one example of or combinations of examples of dental abutments described herein. Each of the plurality of dental abutments can be selectively spaced along the bridge at selected locations that can correspond to selected tooth roots of a patient. The bridge can lie generally in a plane extending between the top surfaces and the bottom surfaces of the main bodies of the apical portions of adjacent abutments.

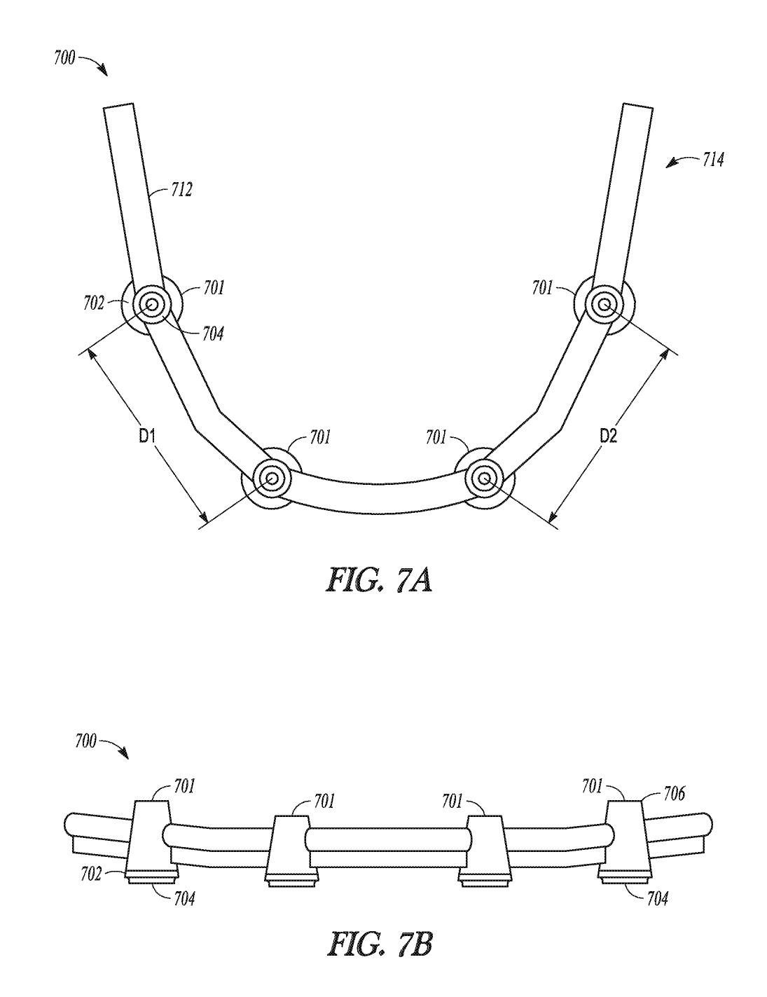

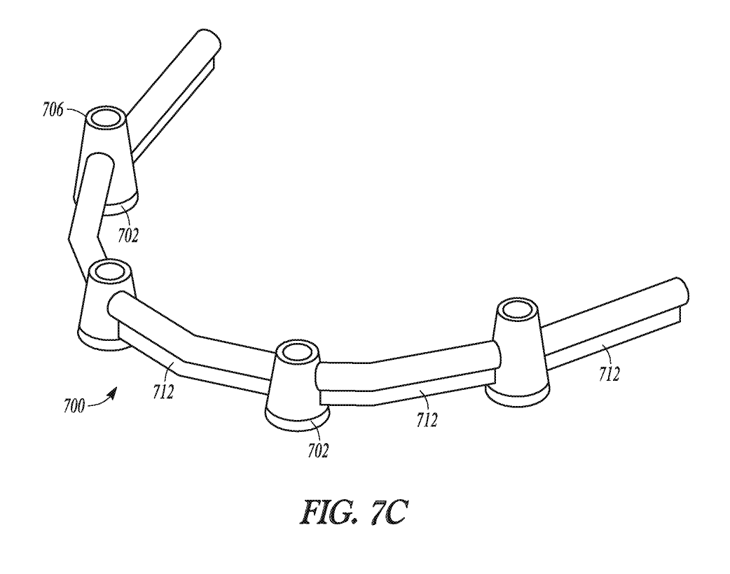

The dental systems can comprise multiple-tooth restorations, such as screw-retained apparatuses, including screw-retained bars, bridges and frameworks. As illustrated in FIGS. 7A-7C, one implementation of a dental system can be a “Hader bar” or “Dolder bar.” The dental system 700 can include a plurality of abutments 701 that can be secured into a common framework 714, such as by a screw retained bar 712. Abutments 701 can be separated from one another at selected distances (e.g., D1, D2) that can correspond to distances between given tooth roots of a given patient (either adjacent tooth roots or non-adjacent tooth roots). Additionally, the common framework 714, here, the screw-retained bar (i.e., the Hader bar or Dolder bar) can be shaped to align with one of the upper and lower jaw of the patient, as appropriate. As illustrated in FIGS. 7A-C, the abutments 701 include the apical portion 702 and the implant interface 704 extending from the apical portion 702.

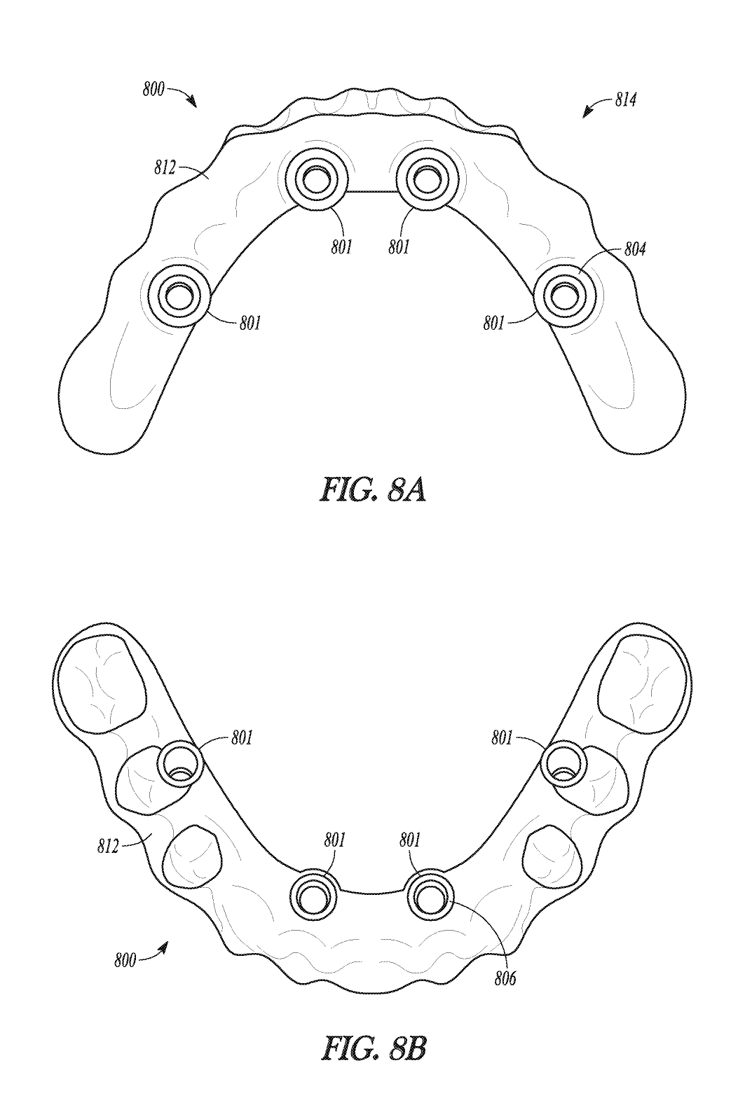

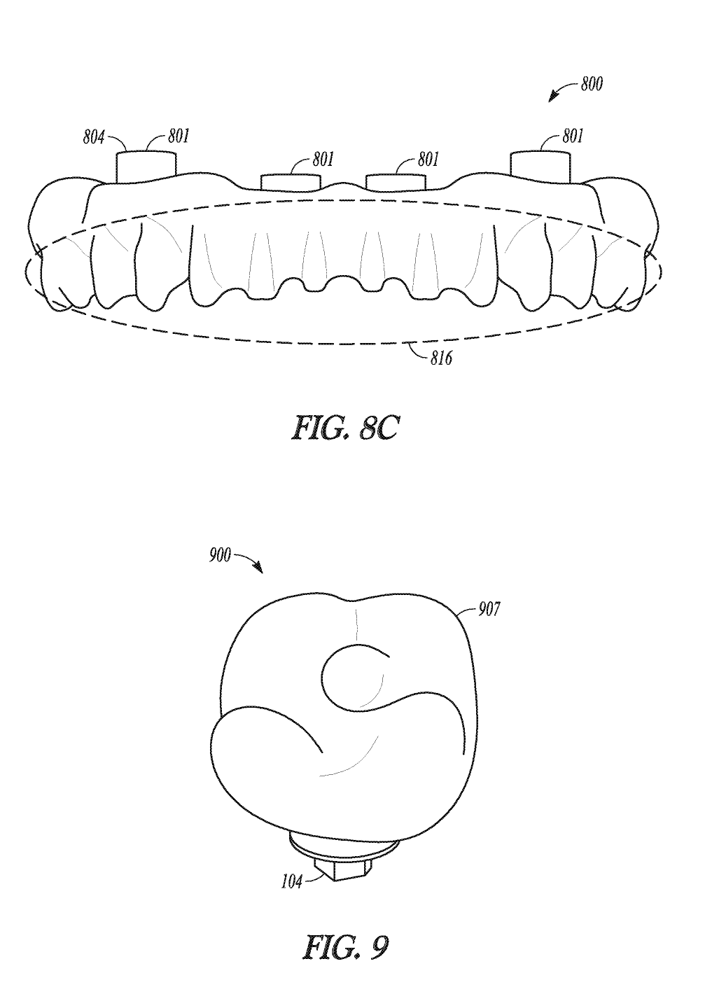

As illustrated in FIGS. 8A-8C, another implementation of a dental system can be a “Toronto Bridge.” The dental system 800 can include a plurality of abutments 801 that can be secured by a bridging element 812 that can comprise a Toronto bridge 814. The bridging element 812 can be can be shaped to align with one of the upper and lower jaw of the patient, as appropriate. Abutments 801 can be separated from one another at selected distances that can correspond to distances between given tooth roots of a given patient (either adjacent tooth roots or non-adjacent tooth roots). As illustrated in FIG. 8C, the dental system 800 can comprise a patient specific bridge 816 having dental prostheses placed over and secured to the coronal portions of the abutments 801. The dental system can be further processed to provide porcelain and gingiva coloration before implantation into a patient. The abutments in FIGS. 7A-C, 8A-C, and 9 can be formed from any of the materials, screw machining methods, and additive manufacturing methods described herein.

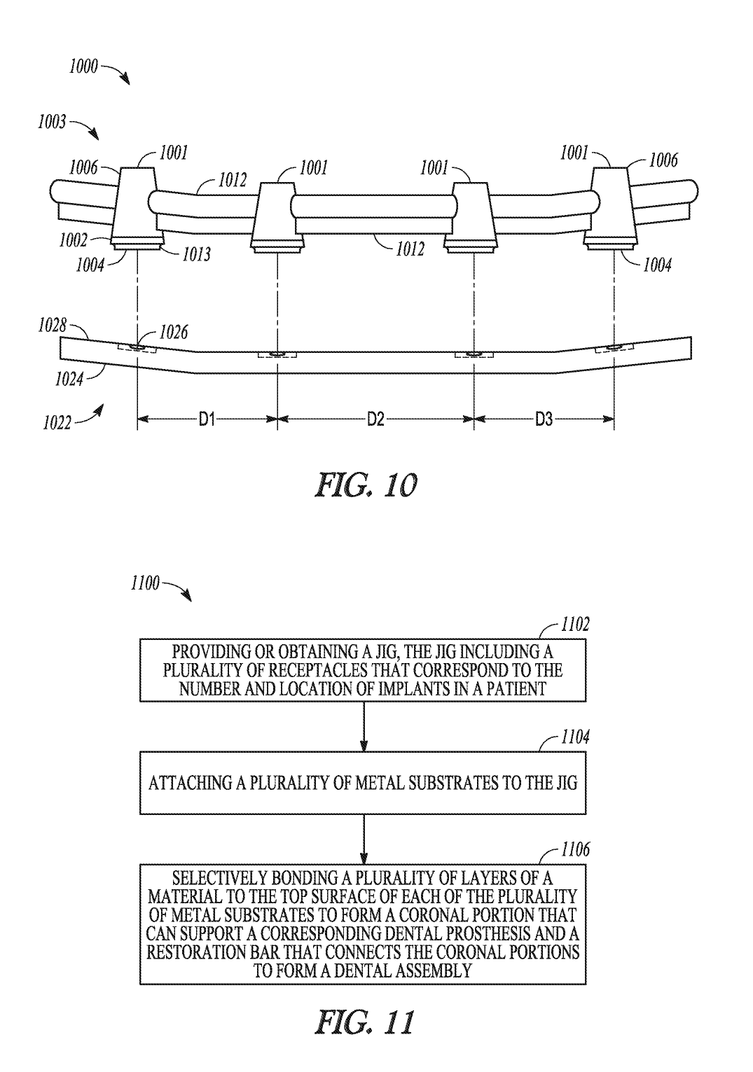

In another aspect illustrated in FIG. 10, a dental system assembly 1003 is provided and includes a jig 1022 and a dental system 1000. The jig 1022 can be used during the manufacturing of the dental system 1000. The jig 1022 can include an elongate body 1024 having a plurality of receptacles 1026 configured to receive the implant interface 1004 of the apical portion 1002 of the abutment 1001.

In multiple-tooth restorations such as bars, bridges and frameworks, the accuracy of the spacing between the abutments corresponding to the spacing of the dental implants has a low tolerance. For example, if the accuracy of the spacing of the abutments relative to the spacing of the implants is outside of a threshold, the coupling between the abutments and the dental implants can be non-passive and stress the dental implants as the abutments are secured to the dental implant. Additive manufacturing techniques can have a greater tolerance compared to machining techniques, such as milling. Thus, to maintain precision of the spacing of the abutments along the multiple-tooth restorations, the present teachings provide the jig 1022 that can locate the apical portions 1002 precisely in the additive manufacturing machinery. The precision location corresponds with the location of the implants in the patient. The use of the jig 1022 assures that the location of the apical portions 1002 on the finished multi-tooth restoration matches the implant locations to assure a passive fitting multi-tooth restoration that minimizes the stress on the implant.

In one aspect, the jig 1022 can be fabricated using machining techniques such as milling, punching or electro-discharge machining (EDM). To obtain the precise location of the implants positioned within a patient, a dental scanner can be used. For example, the dental lab scanners can be very precise (e.g., within 10 microns) and can capture implant data from stone models made from conventional dental impressions. Additionally, intra oral scanners can deliver similar accuracy and obtain implant position by scanning the implant position more directly (e.g., a component is fastened directly to the implant just to get above the gum). The scan data from either the dental lab scanner or the intra oral scanner system can be converted into software that can create CNC code used to guide the machining operation used to produce the jig 1022.

Additionally, other methods can be used to determine the location of the implants. For example, a traditional impression and stone model can be made and the position of the implant sites can be digitized using a probe scanner (CMM) machine. In another method, x-y-z data can be manually extracted from a stone model using a vision system (Micro-Vu) or other precision measuring instrument and manually input or programed into a milling, EDM or punch machine. In another method, an additive manufacturing process with high precision can be used. For example, a blank jig with a cut out (e.g., cavity) that generally describes the implant location can be produced. Additive manufacturing can be used to fill this cavity to form holes in the location where the inserts are to be placed. That is, the additive manufacturing is used to alter the generally cavity (e.g., by partially filling the cavity) to form precise receptacles that correspond to the location of the implants in the patient. Additionally, combinations of the methods described herein can be used.

The jig 1022 material can be dimensionally stable, temperature resistant, and not stick to the metal, plastic or ceramic powders, strings or liquids used in additive manufacturing methods. For example, the material of the jig 1022 can include, but is not limited to, machinable ceramics such Corning Macor®; calcium silicate based such as Duratec 750 or others; other ceramics; graphite; Cr-based alloys; stainless steels; Ni-, Fe-, and Co-Base Superalloys; other high Nickle alloys such as Monel, Iconel; refractory metals such as Niobium, Molybdenum, Tantalum, Tungsten, Rhenium; other metals; high temperature plastics such as Vespel, Torlon, Ryton; other plastics; polysialate; geopolymer; glass-ceramic composites; other composites; base substrates (e.g., metal, ceramic, plastic, composite) treated with high temperature non-stick coatings (e.g., fluoropolymer coating or refractory paint.).

As discussed herein, the jig 1022 includes an elongate body 1024 having a plurality of receptacles 1026 configured to receive the implant interface 1004 of the apical portion 1002 of the abutment 1001. While shown as only extending partially through the elongate body 1024, the receptacles 1026 can form an opening extending through the entire width of the elongate body 1024. The spacing between the receptacles 1026 (e.g., D1, D1, D3) along the jig 1022 is formed to correspond to the location of the implants of a patient, as discussed herein. An apical portion 1002 can be placed on the jig 1022. For example, the implant interface 1004 of an apical portion 1002 can be received within a corresponding receptacle 1026 and a bottom surface 1013 of the apical portion 1002 can abut a top surface 1028 of the jig 1028. In another aspect, the receptacles 1026 can be configured to receive a portion of the apical portion 1002.

Once the apical portions 1002 are located along the jig 1022, the additive manufacturing can begin and can form the coronal portion 1006 of the abutment 1001 and the bar 1012 to form a framework or multi-tooth restoration. The coronal portion 1006 and the bar 1012 can be formed of any of the materials described herein for the abutments. For example, metal can be used for permanent fixtures and plastic and ceramic can be used for temporary fixtures. Moreover, while the jig 1022 shown in FIG. 10 is used to form a dental system 1000 similar to the dental system shown in FIGS. 7A-C, the jig 1022 can also be used to form dental system similar to those shown in FIGS. 8A-C. For example, additive manufacturing can be used to form the coronal portions of abutments 801 and the bridging elements 812, 816.

FIG. 11 illustrates another method 1100 of manufacturing a dental assembly for use with a dental implant 103. The method can comprise (i) providing or obtaining a jig, where the jig includes a plurality of receptacles that correspond to the number and location of implants in a patient (step 1100); attaching a plurality of metal substrates to the jig (step 1104); and selectively bonding a plurality of layers of a material to the top surface of each of the plurality of metal substrates to form a coronal portion that can support a corresponding dental prosthesis and restoration bar that connects the coronal portions to form a dental assembly (step 1106).

At step 1102, providing the jig can include providing jig 1022 shown in FIG. 10. At step 1104, attaching a plurality of metal substrates to the jig can include attaching a plurality of apical portions 1002 of an abutment to the jig 1022. For example, as discussed herein, the implant interface 1004 can be inserted into a receptacle 1026 of the jig 1022. At step 1106, selectively bonding a plurality of layers to the top surface of each of the plurality of metal substrates to form a coronal portion that can support a corresponding dental prosthesis and restoration bar that connects the coronal portions to form a dental assembly can include using additive manufacturing to form a dental assembly. For example, the coronal portion 1006 and the bar 1012 of the dental assembly 1000 can be formed using additive manufacturing. As discussed herein, the jig 1022 is used for precisely positioning the abutments to minimize stress on the dental implants. The method 1100 can be used to form dental assemblies similar to dental assemblies shown in FIGS. 7A-C and 8A-C.

Optionally, the method 1100 can further include inserting a retaining screw longitudinally through a hole disposed in the metal substrate (e.g., apical portion 1002) extending from the top surface to a bottom surface thereof prior to selectively bonding the plurality of layers of a second material to the top surface of the metal substrate. Optionally, the method 1100 can optionally comprise screw machining an implant interface in a bottom surface of the metal substrate to form an implant interface that can be matingly engageable with a corresponding interface receptacle disposed in a dental implant. Any of the materials, screw machining methods, and additive manufacturing methods described can be used.

Some numbered examples of the present disclosure follow.

Example 1 is an abutment comprising an apical portion comprising a main body having a top surface, an opposed bottom surface, and a screw-machined implant interface that can extend from the bottom surface that can be matingly engageable with a corresponding interface receptacle disposed in a dental implant, wherein the apical portion can comprise a first material; and a coronal portion additively formed from a second material on the top surface of the main body of the apical portion, the coronal portion for supporting a dental prosthesis.

In Example 2, the subject matter of Example 1 optionally includes wherein the second material can be at least partially selectively direct metal laser-sintered onto the top surface of the apical portion.

In Example 3, the subject matter of any one or more of Examples 1-2 optionally include wherein the second material can include titanium or a titanium alloy.

In Example 4, the subject matter of any one or more of Examples 1-3 optionally include wherein the second material can be at least partially selectively electron-beam melted onto the top surface of the apical portion.

In Example 5, the subject matter of any one or more of Examples 1-4 optionally include or 4, wherein the second material can include plastic or ceramic.

In Example 6, the subject matter of any one or more of Examples 1-5 optionally include wherein the first material can include titanium or a titanium alloy.

In Example 7, the subject matter of any one or more of Examples 1-6 optionally include wherein the first material can include cobalt chrome.

In Example 8, the subject matter of any one or more of Examples 1-7 optionally include wherein the screw-machined implant interface can further include a computer numerical controlled Swiss screw machined implant interface.

In Example 9, the subject matter of any one or more of Examples 1-8 optionally include wherein a circumference of a cross-section of the implant interface can be hexagonal, conical, a spline, an octagonal, and a lobular shape.

In Example 10, the subject matter of any one or more of Examples 1-9 optionally include wherein a circumference of a cross-section of the implant receptacle can be hexagonal, conical, a spline, an octagonal, and a lobular shape.

In Example 11, the subject matter of any one or more of Examples 1-10 optionally include wherein the apical portion can have a hole disposed therein extending along a longitudinal axis from the top surface to the bottom surface and further including a retaining screw that can extend through the hole disposed in the apical portion, wherein a head of the retaining screw can be at least partially encapsulated by the coronal portion.

Example 12 is a method of manufacturing an abutment for use with a dental implant, the method comprising: providing or obtaining a metal substrate comprising a main body having a top surface; and selectively bonding a plurality of layers of a second material to a top surface of the metal substrate to form a coronal portion for supporting a dental prosthesis.

In Example 13, the subject matter of Example 12 optionally includes screw machining an implant interface in a bottom surface of the metal substrate to form an implant interface that can be matingly engageable with a corresponding interface receptacle disposed in a dental implant.

In Example 14, the subject matter of any one or more of Examples 12-13 optionally include wherein screw machining the implant interface can further include computer numerical controlled Swiss screw machining the implant interface.

In Example 15, the subject matter of any one or more of Examples 12-14 optionally include wherein selectively bonding a plurality of layers of a second material can include direct metal laser sintering a plurality of layers of a second material.

In Example 16, the subject matter of any one or more of Examples 12-15 optionally include wherein the second material can be one of titanium, a titanium alloy, a plastic, and a ceramic and the metal substrate is one of titanium, a titanium allow, and cobalt chrome.

In Example 17, the subject matter of any one or more of Examples 12-16 optionally include inserting a retaining screw longitudinally through a hole disposed in the metal substrate extending from the top surface to a bottom surface thereof prior to selectively bonding a plurality of layers of a second material to the top surface of the metal substrate.

Example 18 is a method of manufacturing a dental system, the method comprising: providing or obtaining a plurality of metal substrates, each metal substrate comprising main body having a top surface; screw machining an implant interface in a bottom surface of each of the plurality of metal substrates to form an implant interface that can be matingly engageable with a corresponding interface receptacle disposed in a corresponding dental implant; and selectively bonding a plurality of layers of a second material to the top surfaces of each of the plurality of metal substrates to form a coronal portion for supporting a corresponding dental prosthesis.

In Example 19, the subject matter of Example 18 optionally includes coupling each of the plurality of metal substrates to an elongate bridge such that each of the plurality of metal substrates can be spaced along the bridge at selected locations corresponding to selected tooth roots of a patient.

Example 20 is a dental system comprising a plurality of abutments for use in a dental implant system, each abutment of the plurality of abutment comprising: an apical portion that can comprise a main body having a top surface, an opposed bottom surface, and a screw-machined implant interface extending from the bottom surface that can be matingly engageable with a corresponding interface receptacle disposed in a dental implant, wherein the apical portion can comprise a first material, wherein the apical portion can have a hole disposed therein extending along a longitudinal axis from the top surface to the bottom surface; and a coronal portion that can be additively formed from a second material on the top surface of the main body of the apical portion, the coronal portion for supporting a dental prosthesis; and a retaining screw that can extend through the hole in the apical portion, wherein a head of the retaining screw can be at least partially encapsulated by the coronal portion; and an elongate bridge, wherein each of the plurality of abutments can be selectively spaced along the bridge at selected locations corresponding to selected tooth roots of a patient.

In Example 21, the subject matter of Example 20 optionally includes wherein the second material can be selectively direct metal laser-sintered onto the top surface of the apical portion.

In Example 22, the subject matter of any one or more of Examples 20-21 optionally include wherein the second material can be selectively electron-beam melted onto the top surface of the apical portion.

In Example 23, the subject matter of any one or more of Examples 20-22 optionally include wherein the screw-machined implant interface can further comprise a computer numerical controlled Swiss screw machined implant interface.

In Example 24, the subject matter of any one or more of Examples 20-23 optionally include −23, wherein the dental apparatus can comprise a screw-retained apparatus.

In Example 25, the subject matter of Example 24 optionally includes wherein the screw-retained apparatus can comprise one of a bar, bridge, and a framework.

In Example 26, the subject matter of any one or more of Examples 24-25 optionally include wherein the screw-retained apparatus can comprise one of a Hader bar and a Dolder bar.

In Example 27, the subject matter of any one or more of Examples 24-26 optionally include wherein the screw-retained apparatus can comprise a Toronto bridge.

Example 28 is a method of manufacturing a dental system, the method comprising: providing or obtaining a jig, where the jig can include an elongated body having a plurality of receptacles that can correspond to the number and location of implants in a patient; attaching a plurality of metal substrates to the jig; and selectively bonding a plurality of layers of a material to the top surface of each of the plurality of metal substrates to form a coronal portion that can support a corresponding dental prosthesis and restoration bar that can connect the coronal portions to form a dental assembly.

In Example 29, the subject matter of Example 28 optionally includes wherein the plurality of receptacles can be formed in a top surface of the elongated body.

In Example 30, the subject matter of any one or more of Examples 28-29 optionally include wherein the plurality of receptacles can be holes extending from a top surface of the elongated body to a bottom surface of the elongated body.

In Example 31, the subject matter of any one or more of Examples 28-30 optionally include wherein the metal substrates can include a main body, a top surface, and a bottom.

In Example 32, the subject matter of Example 31 optionally includes wherein the bottom surface can be an implant interface that can be matingly engageable with a corresponding interface receptacle disposed in a corresponding dental implant.

In Example 33, the subject matter of any one or more of Examples 28-32 optionally include inserting a retaining screw longitudinally through a hole disposed in the metal substrate extending from the top surface to a bottom surface thereof prior to selectively bonding a plurality of layers of a the material to the top surface of the metal substrate.

In Example 34, the subject matter of any one or more of Examples 28-33 optionally include wherein the metal substrate can be formed from at least one or titanium, a titanium alloy, and cobalt chrome and the coronal portion and the restoration bar can be formed from at least one of titanium, titanium alloy, a plastic, and a ceramic.

In Example 35, the subject matter of any one or more of Examples 28-34 optionally include wherein attaching a plurality of metal substrates to the jig can include inserting at least the implant interface of a metal substrate into a corresponding receptacle of the jig.

Example 36 is a dental system assembly, comprising: a dental implant system, including: an apical abutment portion including a main body having a top surface, an opposed bottom surface, and a screw-machined implant interface extending from the bottom surface that can be matingly engageable with a corresponding interface receptacle disposed in a dental implant, wherein the apical portion can comprise a first material, wherein the apical portion can have a hole disposed therein extending along a longitudinal axis from the top surface to the bottom surface; and a coronal abutment portion and a restorative bar additively formed from a second material on the top surface of the main body of the apical portion, the coronal portion for supporting a dental prosthesis, and the restorative bar connecting the coronal portions to form the dental implant system; and a jig including an elongate body and a plurality of receptacles that correspond to the number and location of implants in a patient.

Each of these non-limiting examples can stand on its own, or can be combined in various permutations or combinations with one or more of the other examples.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An abutment, comprising:
an apical portion comprising a main body having a top surface, an opposed bottom surface, and a screw-machined implant interface extending from the bottom surface that is matingly engageable with a corresponding interface receptacle disposed in a dental implant, wherein the apical portion comprises a first material; and
a coronal portion additively formed from a second material on the top surface of the main body of the apical portion, the coronal portion for supporting a dental prosthesis.

2. The abutment of claim 1, wherein the second material is at least partially selectively direct metal laser-sintered onto the top surface of the apical portion.

3. The abutment of claim 1, wherein the second material includes titanium or a titanium alloy.

4. The abutment of claim 1, wherein the second material is at least partially selectively electron-beam melted onto the top surface of the apical portion.

5. The abutment of claim 1, wherein the second material includes plastic or ceramic.

6. The abutment of claim 1, wherein the first material includes titanium or a titanium alloy.

7. The abutment of claim 1, wherein the first material includes cobalt chrome.

8. The abutment of claim 1, wherein the screw-machined implant interface further includes a computer numerical controlled Swiss screw machined implant interface.

9. The abutment of claim 1, wherein a circumference of a cross-section of the implant interface is hexagonal, conical, a spline, an octagonal, and a lobular shape.

10. The abutment of claim 1, wherein a circumference of a cross-section of the implant receptacle is hexagonal, conical, a spline, an octagonal, and a lobular shape.

11. The abutment of claim 1, wherein the apical portion has a hole disposed therein extending along a longitudinal axis from the top surface to the bottom surface and further including a retaining screw extending through the hole disposed in the apical portion, wherein a head of the retaining screw is at least partially encapsulated by the coronal portion.

12. A method of manufacturing an abutment for use with a dental implant, the method comprising:
providing or obtaining a metal substrate comprising a main body having a top surface; and
selectively bonding a plurality of layers of a second material to a top surface of the metal substrate to form a coronal portion for supporting a dental prosthesis.

13. The method of claim 12, further including screw machining an implant interface in a bottom surface of the metal substrate to form an implant interface that is matingly engageable with a corresponding interface receptacle disposed in a dental implant.

14. The method of claim 12, wherein screw machining the implant interface further includes computer numerical controlled Swiss screw machining the implant interface.

15. The method of claim 12, wherein selectively bonding a plurality of layers of a second material includes direct metal laser sintering a plurality of layers of a second material.

16. The method of claim 12, wherein the second material is one of titanium, a titanium alloy, a plastic, and a ceramic and the metal substrate is one of titanium, a titanium allow, and cobalt chrome.

17. The method of claim 12, further including inserting a retaining screw longitudinally through a hole disposed in the metal substrate extending from the top surface to a bottom surface thereof prior to selectively bonding a plurality of layers of a second material to the top surface of the metal substrate.

18. A method of manufacturing a dental system, the method comprising:
providing or obtaining a plurality of metal substrates, each metal substrate comprising main body having a top surface;
screw machining an implant interface in a bottom surface of each of the plurality of metal substrates to form an implant interface that is matingly engageable with a corresponding interface receptacle disposed in a corresponding dental implant; and
selectively bonding a plurality of layers of a second material to the top surfaces of each of the plurality of metal substrates to form a coronal portion for supporting a corresponding dental prosthesis.

19. The method of claim 18, further comprising coupling each of the plurality of metal substrates to an elongate bridge such that each of the plurality of metal substrates are spaced along the bridge at selected locations corresponding to selected tooth roots of a patient.

20. A dental system, comprising:
a plurality of abutments for use in a dental implant system, each abutment of the plurality of abutment comprising:
an apical portion comprising a main body having a top surface, an opposed bottom surface, and a screw-machined implant interface extending from the bottom surface that is matingly engageable with a corresponding interface receptacle disposed in a dental implant, wherein the apical portion comprises a first material, wherein the apical portion has a hole disposed therein extending along a longitudinal axis from the top surface to the bottom surface; and
a coronal portion additively formed from a second material on the top surface of the main body of the apical portion, the coronal portion for supporting a dental prosthesis; and
a retaining screw extending through the hole in the apical portion, wherein a head of the retaining screw is at least partially encapsulated by the coronal portion; and
an elongate bridge, wherein each of the plurality of abutments are selectively spaced along the bridge at selected locations corresponding to selected tooth roots of a patient.
